(19) United States
(12) Patent Application Publication
(10) Pub. No.: US 2005/0045208 A1
(43) Pub. Date: Mar. 3, 2005

(54) Apparatus and method for cleaning semiconductor substrates

(76) Inventors: Sang-Oh Park, Gyeonggi-do (KR); Hun-Jung Yi, Gyeonggi-do (KR)

Correspondence Address: VOLENTINE FRANCOS, P.L.L.C.;Suite 150, 12200 Sunrise Valley Drive, Reston, VA, 20191, US

(21) Appl. No.: 10/891,110

(22) Filed: Jul. 15, 2004

(30) Foreign Application Priority Data
Aug. 26, 2003 (KR) 2003-59118

(51) Int. Cl. B08B 3/02

(52) U.S. Cl. 134/18; 134/25.4; 134/26; 134/200; 134/94.1; 134/95.3; 134/102.3; 134/95.1; 134/902

(57) ABSTRACT

A method of and apparatus for cleaning semiconductor substrates prevents the drying fluid used to dry the substrates from condensing. The apparatus has a chamber having an exhaust port that defines a path along which the drying fluid, e.g., IPA vapor, is exhausted. The degree to which the exhaust path is opened is regulated according to the pressure within the chamber.

### BACKGROUND OF THE INVENTION

1. Field of the Invention

The present invention relates to the fabrication of semiconductor devices. More particularly, the present invention relates to a method of and apparatus for cleaning semiconductor substrates.

2. Description of the Related Art

A variety of semiconductor manufacturing processes are performed to manufacture integrated circuits on a semiconductor wafer. In addition, the wafer must be cleaned to remove residual chemicals, small particles, and contaminants that are produced during the variety of semiconductor manufacturing processes. In particular, removing micro-contaminants attached to a surface of a semiconductor wafer is critical to the manufacturing of high-density integrated circuits.

Such wafer cleaning includes a chemical liquid treating process for etching or stripping contaminants off of the wafers through a chemical reaction, a rinse process for rinsing the chemically treated wafers with deionized (DI) water, and a drying process for drying the rinsed wafers.

A spin dryer using centrifugal force and an isopropyl alcohol (IPA) vapor dryer have been used as apparatus for performing the drying process. A spin dryer is disclosed in U.S. Pat. No. 5,829,156 and an IPA vapor dryer is disclosed in U.S. Pat. No. 5,054,210. However, a spin dryer can not completely remove water drops from a wafer on which complex integrated circuits are being manufactured. Furthermore, the wafer may be contaminated by particles that are returned to the wafer due to a vortex that occurs when the wafer is rotated at a high speed by the spin dryer.

The IPA vapor dryer gives rise to a problem in that watermarks are created on the wafer after the wafer is dried. Furthermore, the IPA vapor dryer creates environmental and safety problems because the IPA vapor dryer uses IPA at a higher temperature than its flash point. Also, if both a spin dryer and the IPA vapor dryer are used, a great amount of time is required to transfer the wafer to the respective units that carry out the rinse and drying processes.

A marangoni dryer has been developed to overcome the foregoing problems. The marangoni dryer dries a wafer without exposing the wafer to air, after the wafer is subjected to a chemical treating process and a rinse process. A wafer drying apparatus using the marangoni principle is disclosed in Japanese Laid-open Patent Publication No. 10-335299. In the marangoni drying process, an IPA layer is formed at the surface of a de-ionized (DI) water bath, and a surface of the wafer is dried by moving the surface through the IPA layer. In the case in which water on part of the wafer is not placed in contact with the IPA layer for some time, the water may remain on the wafer even once that part of the wafer is brought into contact with the IPA layer. In addition, the lower portion of a wafer is less likely to be dried to the same extent as the upper portion of the wafer because the lower portion of the wafer is exposed to the IPA vapor for less time than the upper portion of the wafer.

Thus, in recent years, the IPA dryer has been the most widely used type of dryer apparatus. The IPA dryer operates as follows. After a wafer is completely rinsed, IPA vapor is sprayed onto the wafer within a chamber to exchange DI water attached to the wafer with IPA vapor. Nitrogen gas is then used to complete the drying process. However, in the case of the IPA dryer, some amount of the IPA may condense in the chamber during the drying process. Thus, the condensed IPA keeps the wafer from being dried to the extent desired. Such a problem occurs when the IPA vapor is oversupplied or the pressure in the chamber is very high.

### SUMMARY OF THE INVENTION

An object of the present invention is to provide a wafer cleaning apparatus and a wafer cleaning method which prevent IPA vapor from being condensed in a chamber and efficiently dry a wafer.

According to an aspect of the present invention, a wafer cleaning apparatus has a chamber in which a wafer is rinsed and dried, and the chamber has an exhaust path along which fluid used to dry the wafer is exhausted from the chamber. The apparatus also has a wafer support disposed in the chamber, a supply section that supplies the drying fluid to the chamber, and a regulator. The regulator regulates the rate at which the drying fluid is exhausted from the chamber along the exhaust path based on the pressure within the chamber.

In an exemplary embodiment, the regulator comprises a cutoff plate for blocking the exhaust path or opening at least a portion of the exhaust path, a driving mechanism for moving the cutoff plate, a pressure sensor for measuring the pressure within the chamber, and a controller for controlling the driving mechanism according to the values of the pressure measured by the pressure sensor.

In another exemplary embodiment, the regulator comprises a housing connected to the exhaust path, a cutoff member disposed in the housing and having a pressure-bearing surface communicating with the exhaust path for opening/closing the exhaust path, and a resilient body that biases the cutoff member towards a closed position against the pressure exerted on the pressure-bearing surface thereof. Thus, the degree to which the exhaust path is open is regulated according to the degree to which the resilient body is compressed by the pressure in the chamber.

Preferably, the exhaust path is disposed below the substrate support in the chamber, and the exhaust path has a rectangular cross section.

The supply section includes an injection pipe having injection holes through which the drying fluid is injected into the chamber, a first supply pipe for supplying a first fluid to the injection pipe, and a second supply pipe for supplying a second fluid. First and second flow rate regulating valves are installed in the first and second supply pipes, respectively. The second supply pipe may branch from the first supply pipe at a location between the injection pipe and the first flow rate regulating valve. Preferably, the first fluid is alcohol vapor and the second fluid is a dry gas. When the alcohol vapor is supplied into the chamber, the amount of the dry gas flowing along the second supply pipe is regulated according to variations in the amount of the alcohol vapor supplied to the injection pipe such that the total amount of the fluid supplied through the injection pipe is maintained constant.

Preferably, the injection pipe is installed lengthwise in the sidewall of the chamber. The cross-sectional area of the inside of the injection pipe may gradually decrease in a direction away from the first supply pipe. The injection holes of the injection pipe face upwardly in the chamber, and the lid of the chamber may be in the shape of a dome so that the fluid issuing form the injection holes forms a vortex at the top of the chamber.

Furthermore, the apparatus may comprise cleaning liquid solution supply piping. The cleaning liquid solution supply piping comprises an upper supply pipe disposed above the level of the semiconductor substrates disposed in the chamber and a lower supply pipe disposed at a level beneath the semiconductor substrates disposed in the chamber.

Still further, an evaporator is provided to generate the alcohol vapor. The first supply pipe is connected to the evaporator. A vent pipe is connected to the evaporator part to allow some of the vapor in the evaporator to vent to the outside. An open/close valve is installed in the vent pipe.

According to another aspect of the present invention, a method of cleaning semiconductor substrates comprises cleaning a semiconductor substrate in a chamber using a cleaning liquid, subsequently draining the cleaning liquid from the chamber, and subsequently drying the semiconductor substrate in the chamber using drying gas. The drying of the semiconductor substrate is carried out by supplying a drying fluid into the chamber, simultaneously exhausting the drying fluid from the chamber, and regulating the rate at which the fluid is exhausted according to the pressure within the chamber.

The exhaust rate may be regulated by measuring the pressure within the chamber, and moving a plate into the exhaust path by an amount corresponding to the measured value of the pressure. The semiconductor substrate may be cleaned by first injecting a cleaning fluid onto the semiconductor substrate from a location above the semiconductor substrate, and thereafter injecting a cleaning fluid into the chamber from a location beneath the semiconductor substrate in the chamber.

### BRIEF DESCRIPTION OF THE DRAWINGS

FIG. 1 and FIG. 2 are longitudinal sectional views of an embodiment of a wafer cleaning apparatus according to the present invention.

FIG. 3 is a perspective view of a wafer support of the apparatus shown in FIG. 1.

FIG. 4 and FIG. 5 are longitudinal sectional views, similar to those of FIG. 1, but showing a rinse process performed by the apparatus.

FIG. 6 is a longitudinal sectional view of another embodiment of a wafer cleaning apparatus according to the present invention.

FIG. 7 is a side view of an injection pipe of the wafer cleaning apparatus according to the present invention.

FIG. 8 is a cross-sectional view of the pipe taken along line A-A of FIG. 7.

FIG. 9 is a side view of another version of the injection pipe of the wafer cleaning apparatus according to the present invention.

FIG. 10 is a longitudinal sectional view, similar to that of FIG. 6, but showing the direction of flow of a drying fluid supplied by the injection pipe into the chamber.

FIG. 11 is a longitudinal sectional view of another version of a wafer cleaning apparatus according to the present invention in which an injection pipe and an upper supply pipe are provided at different locations than in the embodiment of FIG. 6.

FIG. 12 is a cross-sectional view of an injection pipe having an integrated heater used in the wafer cleaning apparatus according to the present invention.

FIG. 13 is a longitudinal sectional view of a wafer cleaning apparatus having one particular embodiment of a regulator according to the present invention.

FIG. 14 is a partial perspective view of an exhaust port of the apparatus shown in FIG. 13.

FIG. 15 is a longitudinal sectional view, similar to that of FIG. 13, but showing the exhaust port of the wafer cleaning apparatus in a partially open state.

FIG. 16 is a longitudinal sectional view of a wafer cleaning apparatus having another embodiment of a regulator according to the present invention

FIG. 17 is a longitudinal sectional view, similar to that of FIG. 16, but showing the exhaust port of the wafer cleaning apparatus in a partially open state.

FIG. 18 is a flowchart of a wafer cleaning method according to the present invention.

### DETAILED DESCRIPTION OF THE PREFERRED EMBODIMENTS

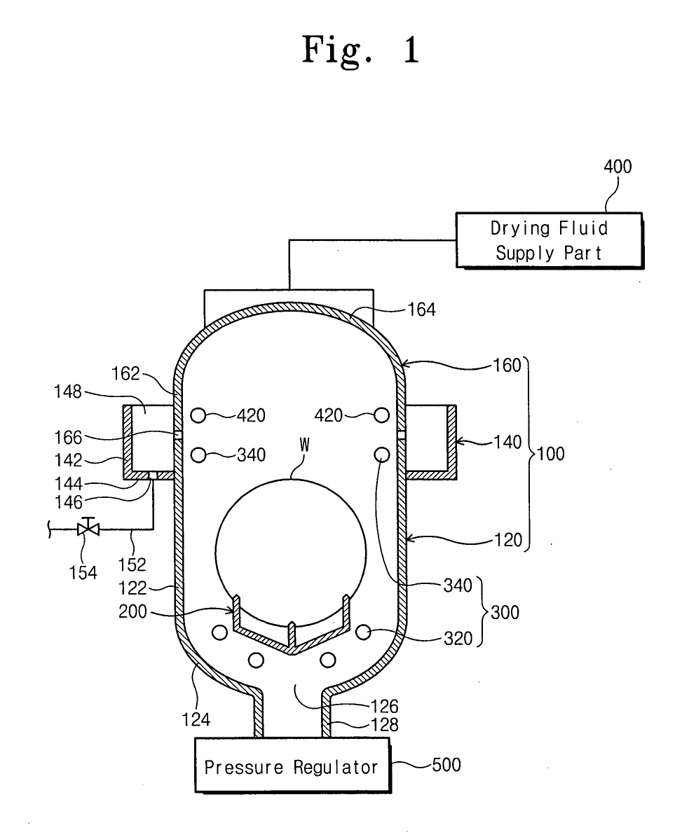

Referring to FIG. 1 and FIG. 2, a wafer cleaning apparatus 1 includes a chamber 100, a wafer support 200, cleaning liquid supply piping 300, a drying fluid supply part 400, and a pressure regulator 500. The chamber 100 has an inner bath 120, an outer bath 140, and a lid 160.

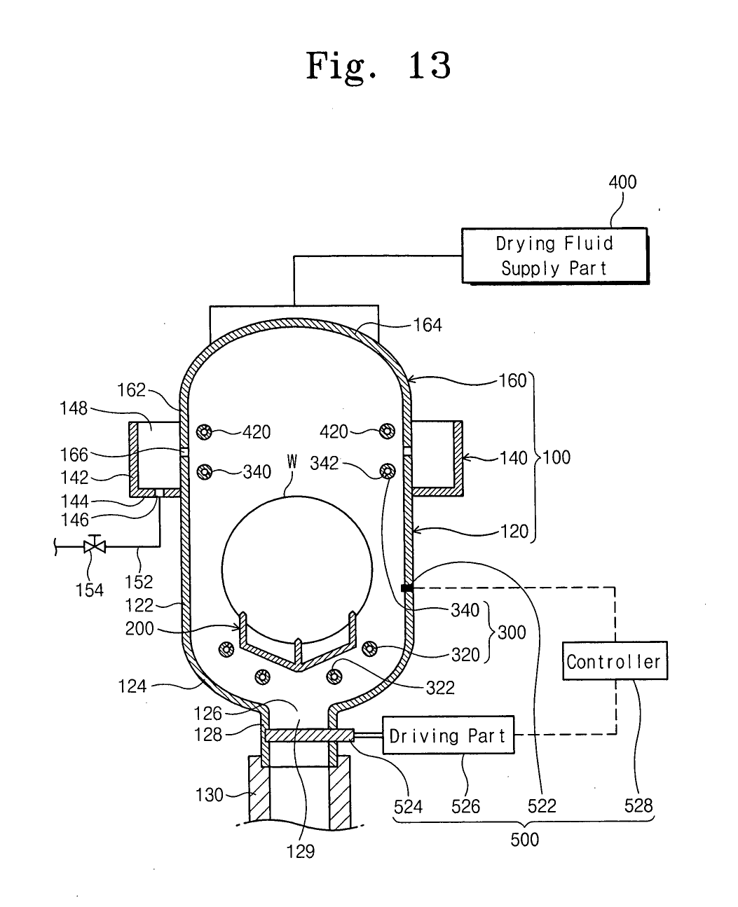

The inner bath 120 offers a space in which a chemical liquid treating process, a rinse process, and a dry process are performed for wafers “W”. The inner bath 120 has an open top, a sidewall 122 in the form of a rectangular parallelepiped, and a bottom 124. The interior of the inner bath 120 is wide enough to receive wafers. The bottom 124 of the inner bath 120 tapers downwardly such that cleaning solution drains readily from the inner bath 120. The center of the bottom 124 has an exhaust hole 126 for exhausting fluid from the inner bath 120. An exhaust port 128 is provided below the exhaust hole 126 and in communication therewith. The exhaust port 128 is connected to an exhaust pipe (130 of FIG. 13). The exhaust pipe 130 may be oriented vertically so that the cleaning solution is exhausted by gravity from the inner bath 120. The lid 160 is disposed on the inner bath 120 such that it can open and close over the top of the inner bath 120. The lid 160 has a sidewall 162 in the form of a rectangular parallelepiped and a dome-shaped top 164. A lower portion of the sidewall 162 has an opening 166. The opening 166 allows cleaning solution to overflow the inner bath 120 during a cleaning process.

The outer bath 140 is disposed around the sidewall 122 of the inner bath 120 and is fixed to the inner bath 120. The outer bath 140 has a bottom 144 and a sidewall 142 extending upwardly from the outer periphery of the bottom 144 of the outer bath 140. The outer bath 140 is connected to the inner bath 120 such that the inner peripheral portion of the bottom 144 of the outer bath 140 is disposed under the opening 166. A drain port 146 is provided at the bottom 144 of the outer bath 140. A drain pipe 152 is connected to the drain port 146, and an open/close valve 154 is installed in the drain pipe 152 to selectively open and close the drain pipe 152. A predetermined volume of space 148 is defined between the sidewall 122 of the inner bath 120 and the sidewall 142 of the outer bath 140. After the cleaning solution in the inner bath 120 flows into the space 148 through the opening 166, the cleaning solution is exhausted to the outside through the exhaust hole 146. A door (not shown) for opening/closing the opening 166 during a cleaning process may be installed at the sidewall 122 of the inner bath 120.

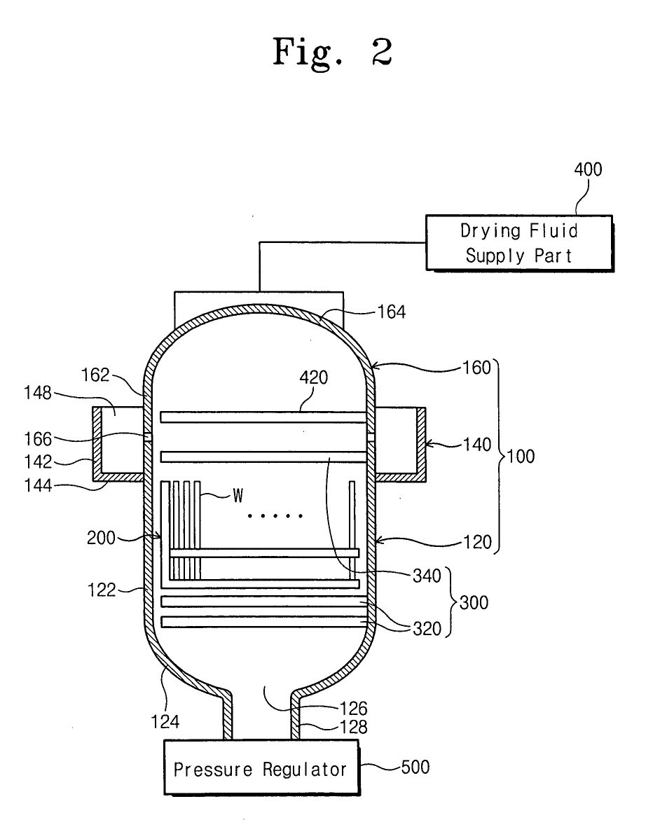

The wafer support 200 is configured to support a plurality of wafers at once during a cleaning process. Referring to FIG. 3, the support 200 has supporting rods 220 and a connecting part 240. Slots 222 are formed in the respective supporting rods 220. Portions of the edges of the wafers “W” are received in the slots 222, respectively. The wafers “W” are thus supported upright by the support 200 such that their main surfaces (surfaces to be processed) are exposed. The wafer support 200 may have three supporting rods 220, whereby about 50 wafers may be received by the support 200 at a time. The ends of the respective supporting rods 220 are fixedly connected to the connecting part 240 such that connecting part 240 connects the supporting rods 220 to each other.

The cleaning liquid supply piping 300 supplies a cleaning liquid into the inner bath 120. During the chemical solution treating process, the cleaning liquid may be a chemical solution such as hydrofluoric (HF) acid, which is suitable for removing particles, metallic contaminants such as copper, or other contaminants such as native oxides. During the rinse process, the cleaning liquid may be deionized water (DI water) used to remove any of the chemical solution that remains on the wafers. The chemical solution and the DI water may be supplied to the inner bath 120 through the same supply piping 300. Alternatively, the supply piping 300 may comprise a supply pipe for supplying the chemical solution and a supply pipe for supplying the DI water independently of one another.

In any case, a chemical solution such as HF acid is supplied from the cleaning liquid supply piping 300 to the inner bath 120 until the inner bath is filled with the chemical solution. The wafers are then moved into the inner bath 120. After the contaminants attached to the wafers are removed by the chemical solution, the rinse process is performed to remove any of the chemical solution adhering to the wafers.

If DI water were injected into the inner chamber 120 above a wafer, the water would flow turbulently and thereby remove contaminants attached to even a fine pattern on the wafer. Unfortunately, the contaminants removed from the wafer in this way could be reattached to the wafer by the very same turbulent flow of DI water. On the other hand, if DI water were injected into the inner chamber 120 at a location beneath a wafer, the DI water would produce a laminar flow that would remove contaminants from the wafer and reduce the likelihood that the contaminants would reattach themselves to the wafer. However, a laminar flow of the DI can hardly remove contaminants attached to a fine pattern on the wafer.

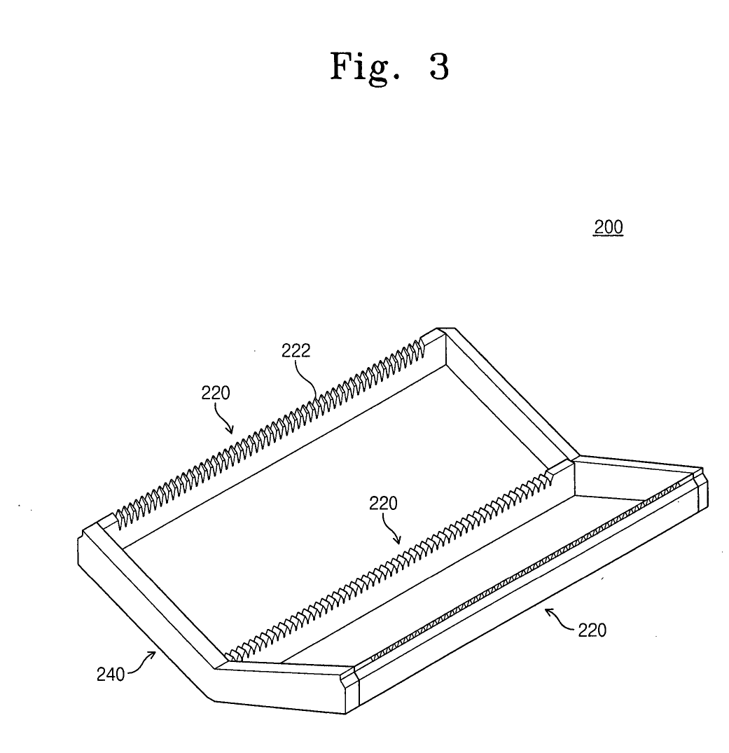

Returning to FIG. 1, in view of the above-described limitations, the cleaning liquid supply piping 300 has lower supply pipes 320 and upper supply pipes 340 that together can efficiently perform the rinse process. The upper supply pipes 340 are disposed in the inner bath 120 above the wafers “W” supported by the wafer support 200, whereas the lower supply pipes 320 are disposed in the inner bath 120 below the wafers “W” supported on the wafer support 200. The upper supply pipes 340 have injection ports (342 in FIG. 4) that are oriented to face downwardly, and the lower supply pipes 320 have injection ports (322 in FIG. 4) that are oriented to face upwardly, to directly inject DI water onto the wafers.

A rinse process using the wafer cleaning apparatus 1 will now be described with reference to FIG. 4 and FIG. 5. According to the present invention, the rinse process is carried out in two steps. In the first step, shown in FIG. 4, DI water is injected from the upper supply pipes 340 onto the wafers “W”. The injected DI water flows turbulently to remove chemical solutions and contaminants attached to the fine patterns on the wafers “W”. The supplying of the DI water from the upper supply pipes 340 ceases once the DI water once a predetermined portion of the inner bath 120 is filled. In the second step, as shown in FIG. 5, DI water is supplied from the lower supply pipes 320. In this case, the DI water travels across the wafers “W” as a laminar flow, and overflows the inner bath 120 to the outer bath 140 through the opening 166.

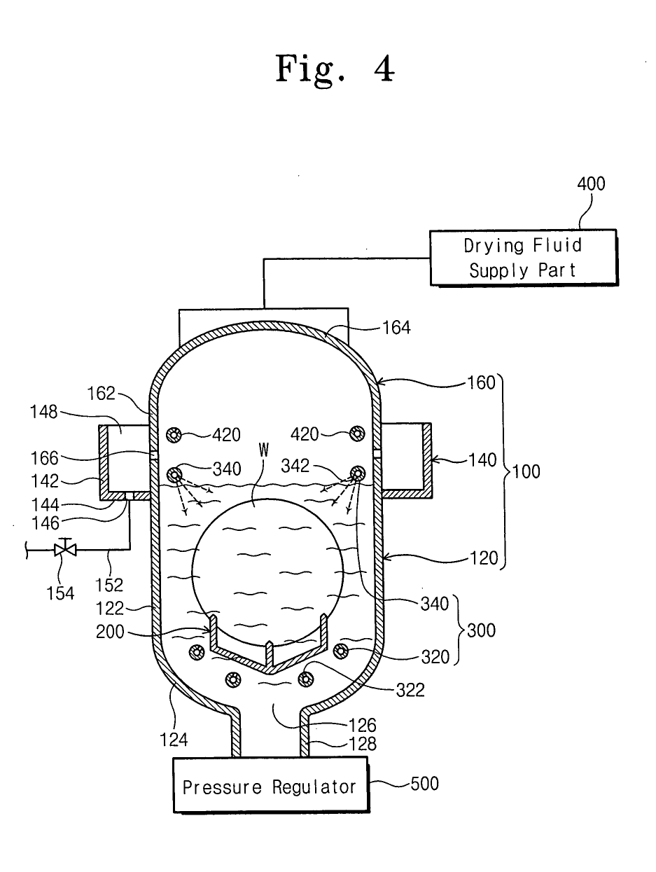

When the rinse process is completed, a drying process is carried out to dry the wafers “W”. Referring to FIG. 6, the drying fluid supply part 400 of the wafer cleaning apparatus 1 comprises injection pipes 420, supply pipes 450 and 460, and an evaporator 440. Alcohol vapor and gas are used by the drying fluid supply part 400 for drying the wafers “W”. Typically, the alcohol is isopropyl alcohol (hereinafter referred to as “IPA”). However, the alcohol may be ethylglycol, 1-propanol, 2-propanol, tetrahydrofurane, 4-hydroxy-4-methyl-2-pentamone, 1-butanol, 2-butanol, methanol, ethanol, acetone, n-propyl alcohol or dimethylether. The gas may be heated nitrogen gas.

The evaporator 440 generates alcohol vapor and comprises a gas can type of body 441. A pipe 480 is connected to the bottom 442 of the body 441. Alcohol is supplied to the pipe 480 from an alcohol storing part 494 in which the alcohol is stored. An open/close valve 482 and a flow rate regulating valve 484 may be installed in the pipe 480. The open/close valve 482 opens and closes the pipe 480, and the flow regulating valve 484 regulates the rate at which alcohol flows into the pipe 480 from the alcohol storing part 494. A pipe 470 is connected to the side 444 of the body 441. Nitrogen gas is supplied to the pipe 470 from the nitrogen gas storing part 492. An open/close valve 472 and a flow rate regulating valve 474 may be installed in the pipe 470. The open/close valve 472 opens and closes the pipe 470, and the flow rate regulating valve 474 regulates the rate at which nitrogen gas flows into the pipe 470 from the nitrogen gas storing part 492.

A first supply pipe 450 is connected to the top 446 of the evaporator 440. The first supply pipe 450 receives alcohol vapor generated in the body 441 and is connected to the injection pipes 420 for directly injecting a drying fluid into the chamber 100. An open/close valve 452 is installed in the first supply pipe 452. A second supply pipe 460 is for supplying the nitrogen gas to the injection pipes 420 directly from the nitrogen gas storing part 492. The second supply pipe 460 branches from the first supply pipe 450. An open/close valve 462 is installed in the second supply pipe 460. The pipe 470 for supplying nitrogen gas to the evaporator 440 may branch from the second supply pipe 460. A vent pipe 490 is connected to the top 446 of the evaporator part 440, and an open/close valve 492 is installed in the vent pipe 490.

Before the wafers are dried using the IPA vapor, the flow path through the first supply pipe 450 connected to the evaporator part 440 is cut off by the open/close valve 452. Thus, the inside of the evaporator 440 is kept at a high pressure. Then the open/close valve 452 is opened. The vent pipe 490 is provided to prevent a large amount of the IPA vapor in the evaporator part 440 from being momentarily supplied when the open/close valve 452 is first opened. Thus, the IPA vapor is supplied into the chamber 100 while some of the IPA vapor in the evaporator 440 continues to be exhausted through the vent pipe 490. The open/close valve 492 is closed after a predetermined period of time.

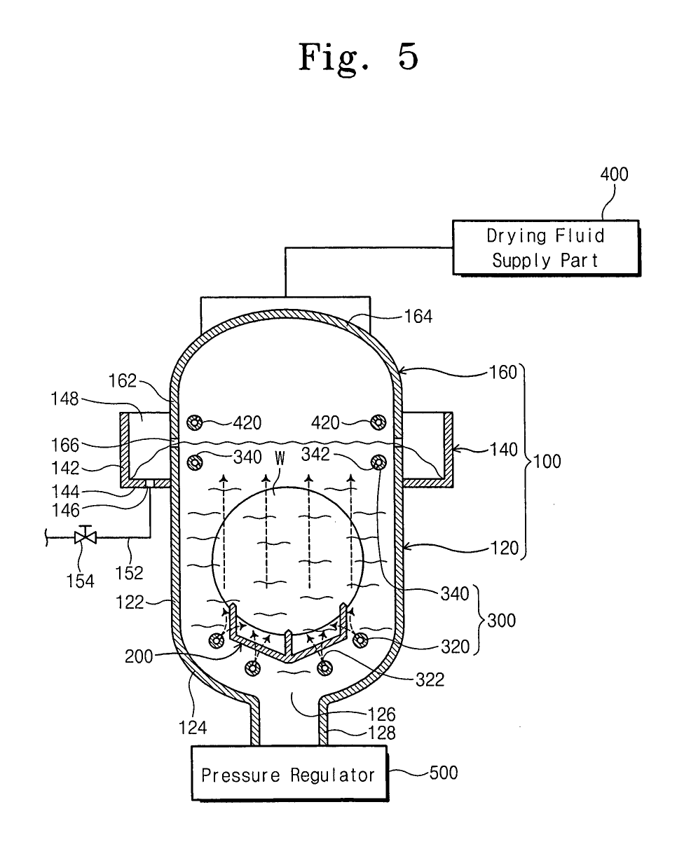

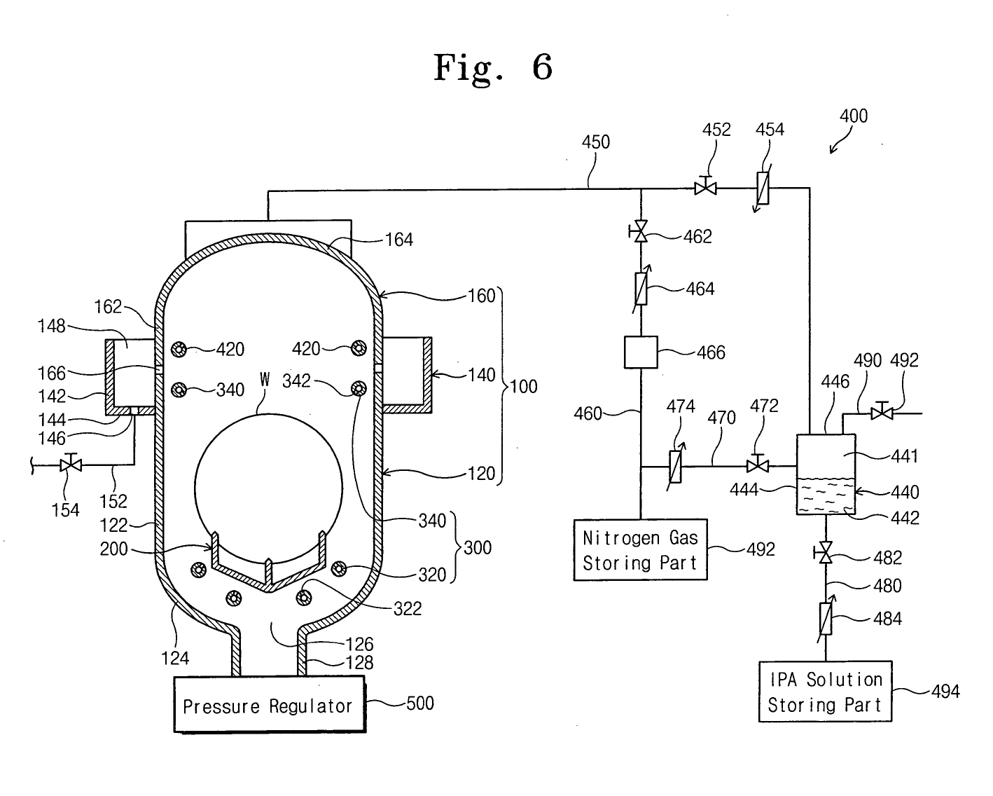

The injection pipes 420 extend within the chamber 100 along both sides of the chamber 100, respectively, at a level above the wafers supported by the wafer support 200. Also, the injection pipes 420 extend longitudinally in directions perpendicular to the major surfaces of the wafers (surfaces to be processed). Referring to FIG. 7 and FIG. 8, each injection pipe 420 has a plurality of injection holes 422, 424, and 426. Each of the injection holes 422, 424, and 426 is oriented to face upwardly. Accordingly, drying fluid injected into the chamber 100 through the injection holes 422, 424, and 426 is directed upwardly in the chamber 100. The injection holes 422, 424, and 426 of the injection pipe 420 may be arranged in a plurality of groups oriented at different angles relative to one another. For example, the injection pipe 420 may have a first group of injection holes 422, a second group of injection holes 424, and third group of injection holes 426. The injection holes 422 of the first group may all be oriented at an angle of 5-20° relative to a horizontal plane. The injection holes 424 of the second group may all be oriented at an angle of 30-50° relative to a horizontal plane. Furthermore, the injection holes 426 of the third group may all be oriented at an angle of 60-80° relative to a horizontal plane.

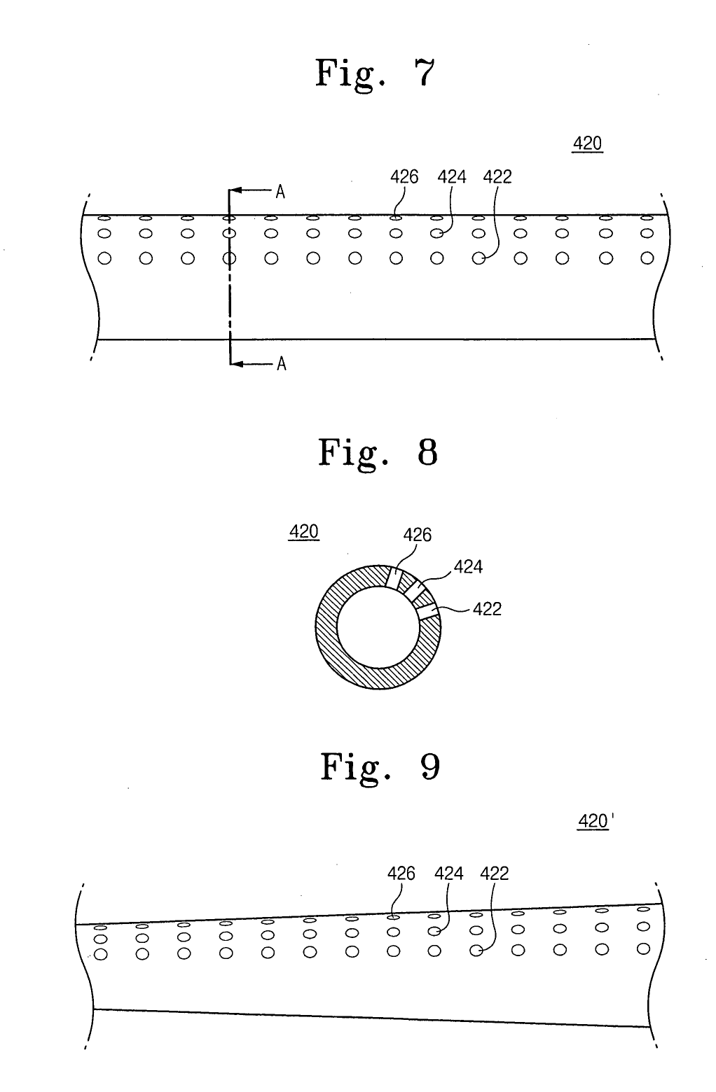

As shown in FIG. 9, each injection pipe 420′ may taper so that the cross-sectional area of its interior becomes smaller in a direction towards its distal end. Alternatively, each injection pipe 420 may have a uniform inner diameter along its length whereas the spacing between the injection holes 422, 424, and 426 varies along the length thereof. In the case in which the injection pipe 420 has a uniform inner diameter, the amount of drying fluid flowing therethrough decreases in a direction away from the first supply pipe 450. By varying the configuration of the injection holes, the injection pipe 420 is thus designed so that the wafers “W” supported by the support 200 in the chamber 100 are dried uniformly regardless of their positions relative to the injection pipe 420.

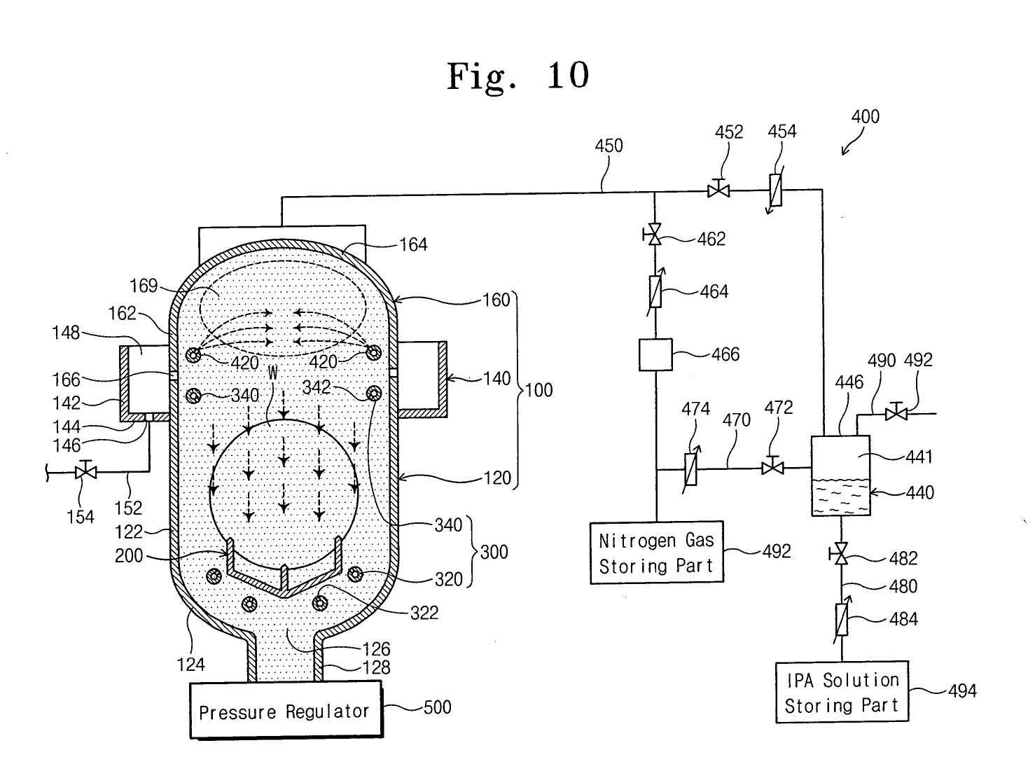

FIG. 10 illustrates the direction of flow of a drying fluid supplied from the injection pipes 420. If the IPA vapor were directly injected onto a wafer, the wafer would not be dried uniformly. That is, a large amount of the IPA vapor would be supplied to areas of the wafer onto which the drying fluid was directly injected, and a significantly smaller amount of the IPA would envelop the other areas of the wafer. As previously stated, the lid 160 is dome-shaped. Therefore, the IPA vapor injected from the injection pipes 420 creates a vortex in a space 169 delimited by the lid 160 and then travels as a laminar flow to the lower portion of the chamber 100. This makes it possible to uniformly supply the IPA vapor over the entire surface of the wafer.

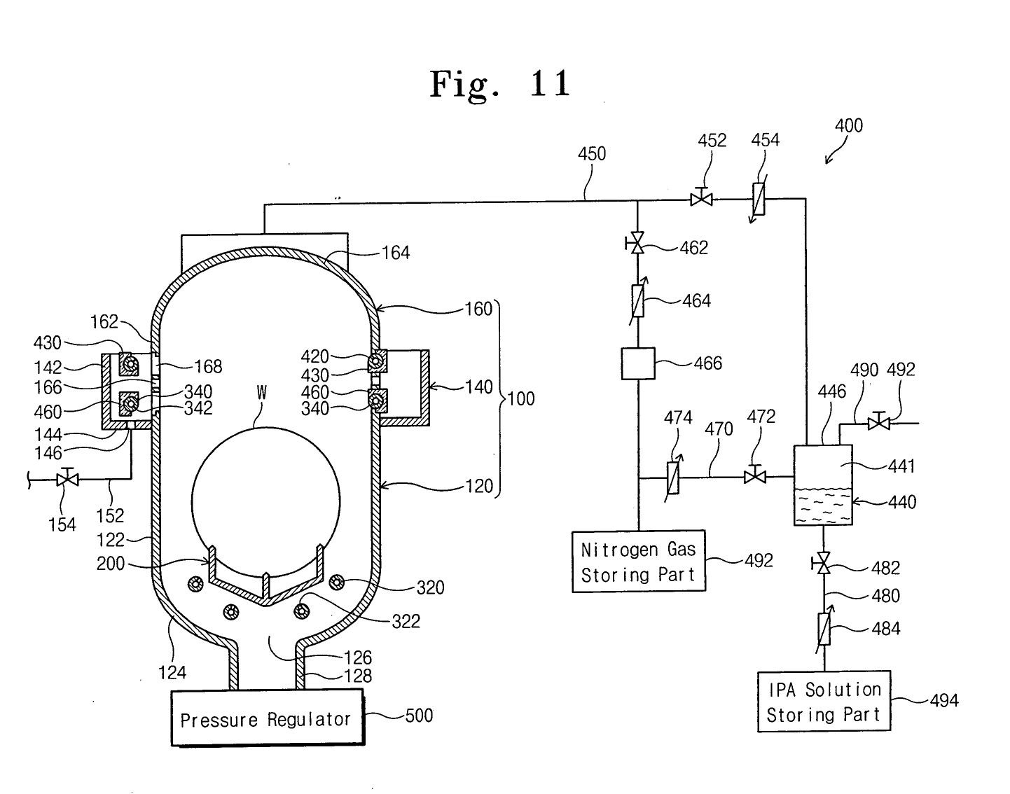

FIG. 11 illustrates another example of the positions at which the injection pipes 420 and upper supply pipes 340 can be installed according to the present invention. Referring to FIG. 11, the injection pipes 420 and the upper supply pipes 340 are disposed in the sidewalls 122 and 162 of the chamber 100, not inside the chamber. More specifically, an opening 168 is formed along both sides of the lid 160, and a module 430 is installed in the opening 168. The injection pipe 420 is received by the module 430. One corner of the module 430 is open so that the injection holes 422, 424, and 426 of the injection pipe 420 are exposed. In this case, the chamber 100 can be smaller than the case in which the pipes 340, 420 are installed in the chamber 100. Thus, the processing time is comparatively less and hence, the throughput is comparatively greater. Furthermore, it is less likely that water will remain on surfaces of the injection pipes 420 and the upper supply pipes 340.

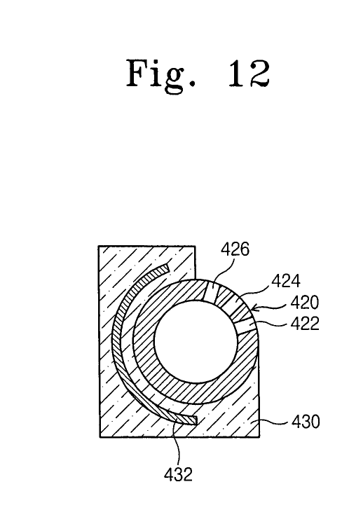

Referring to FIG. 12, the drying fluid supply part 400 has a heater 432 for heating the injection pipes 420. The heater 432 comprises a hot that may be integrated into the module 430 to prevent high-temperature IPA vapor from being condensed while flowing along the injection pipes 420.

Returning to FIG. 6, flow rate regulating valves 454 and 464 are installed in the first supply pipe 460 and the second supply pipe 450, respectively. The flow rate regulating valve 454 is disposed between the evaporator 440 and the location at which the second supply pipe 460 branches from the first supply pipe 450. The amount of the IPA vapor supplied into the chamber 100 is regulated by means of the flow rate regulating valve 454 to prevent the IPA vapor from being oversupplied into the chamber 100. Otherwise, if an excessive amount of the IPA vapor were supplied into the chamber 100, the IPA vapor would condense and thereby prevent the wafers “W” from being dried sufficiently.

The amount of a fluid supplied to the injection pipe 420 varies as the flow rate regulating valve 454 is adjusted. Thus, the rate at which the fluid flows into the chamber 100 changes accordingly. In order to prevent a decrease in the drying efficiency, nitrogen gas is supplied to the second supply pipe 460 while the IPA vapor is supplied to the first supply pipe 450. The flow rate regulating valve 464 is adjusted according to the variation in the rate at which the IPA vapor flows through the first supply pipe 450 to regulate the amount of the nitrogen gas flowing into the second supply pipe 460 such that the total amount of fluid supplied to the injection pipe 420 remains constant. The velocity of the IPA vapor flowing through the first supply pipe 450 is maintained higher than that of the nitrogen gas flowing through the second supply pipe 460 to prevent the nitrogen gas supplied to the second supply pipe 460 from back-flowing to the evaporator 440.

A heater 466 may be installed on the second supply pipe 460 to heat the nitrogen gas flowing in the second supply pipe 460. Thus, high-temperature nitrogen gas is supplied together with the IPA vapor to prevent the IPA vapor from condensing in the injection pipe 420. When the dry process is performed by supplying the heated nitrogen gas into the chamber 100 after the IPA vapor is used, the heated nitrogen gas is supplied into the chamber 100 through the second supply pipe 460, i.e., without the need for a dedicated nitrogen supply pipe.

If the amount of the vapor allowed to flow into the chamber 100 were remarkably larger than the amount of vapor exhausted from the chamber 100, the IPA vapor would condense in the chamber 100. Therefore, it is necessary to regulate the amount of the IPA vapor exhausted from the chamber 100 according to the pressure within the chamber 100. Referring to FIG. 13, the pressure regulator 500 regulates the degree to which the exhaust path 129 is open to control the rate at which the IPA vapor is exhausted from the chamber 100.

The pressure regulator 500 has a cutoff plate 524, a driving part 526, a pressure sensor 522, and a controller 528. The cutoff plate 524 is for opening/closing the exhaust path 129. The cutoff plate 524 may be disposed to open/close the path within the exhaust port 128. Alternatively, the cutoff plate 524 may be disposed to open/close the path within the exhaust pipe 130. The exhaust port 128 has the shape of a rectangular parallelepiped so that the exhaust path 129 has a rectangular cross section. The cutoff plate 524 has the same rectangular shape as the exhaust path 129 and large enough to completely block the exhaust path 129.

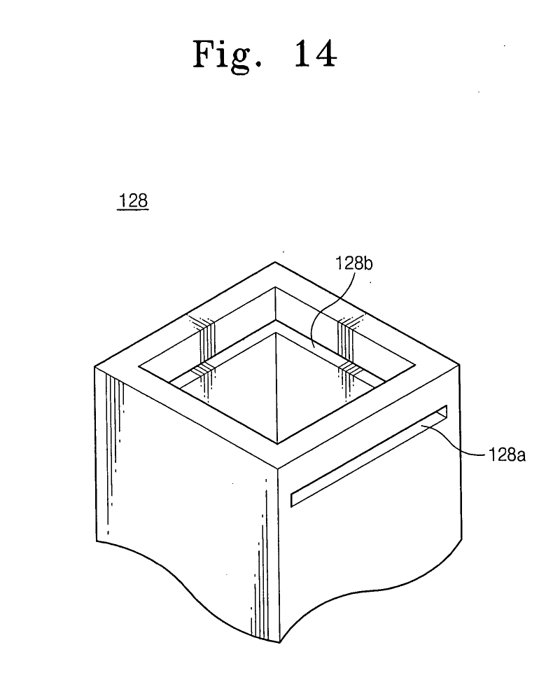

Referring to FIG. 14, one side of the exhaust port 128 has an opening 128a extending therethrough, and the exhaust port 128 also has a guide groove 128b extending in an inner sidewall thereof. The outer peripheral edge portion of the cutoff plate 524 is received in the guide groove 128b so that the movement of the cutoff plate 524 into the exhaust port 128 is guided and the cutoff plate 524 is stably supported. The driving part 526 moves the cutoff plate 524. The driving part 526 may comprise a motor for precisely controlling the movement of the cutoff plate 524. The pressure sensor 522 measures the pressure within the chamber 100, and the sensed value of the pressure is transmitted to the controller 528. In this way, the controller 528 controls the driving part 526 according to the pressure measure by the sensor 522.

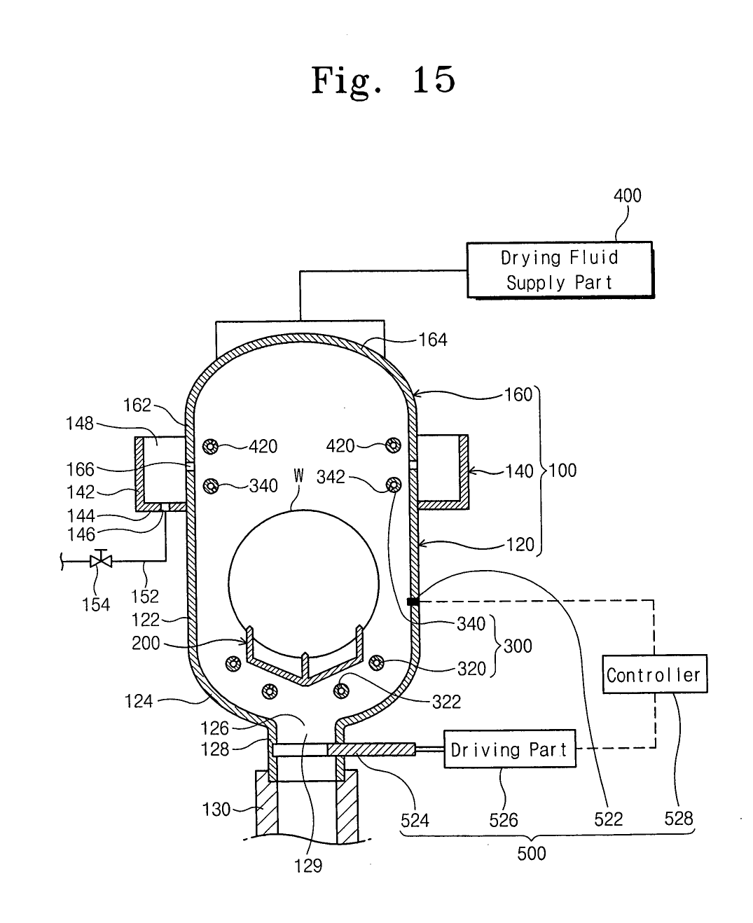

When the drying process starts, the inner pressure of the chamber 100 is low, and the cutoff plate 524 moves into the exhaust port 128 to completely block the exhaust path 129. However, as the IPA vapor supplied into the chamber 100 increases the pressure within the chamber 100, the cutoff plate 524 is retracted to some extent from the exhaust port 128. Thus, the exhaust path 128 is partly opened, as shown in FIG. 15. As the pressure in the chamber 100 becomes even higher, the degree to which the exhaust path 129 is opened is increased. Thus, the pressure inside the chamber 100 is maintained within a predetermined range. The predetermined pressure range is set to prevent the IPA vapor from condensing in the chamber 100 and to achieve a pressure under which the wafers “W” will dry efficiently.

Assuming that the pressure within the chamber 100 is P₁ and the pressure within the exhaust pipe 130 is P₂, the degree to which the exhaust path 129 is opened is regulated such that the pressure P1 is maintained in a range from P₂+(P₂×0.05) to P₂+(P₂×0.5). Preferably, the degree to which the exhaust path 129 is opened is regulated such that the pressure P₁ is maintained within a range of from P₂+(P₂×0.2) to P₂+(P₂×0.3).

Furthermore, the exhaust path 129 may be used to drain the DI water from the chamber 100 before the drying process starts. While the chamber 100 is being drained, the cutoff plate 524 is completely withdrawn from the exhaust port 128 such the exhaust path 129 is completely opened.

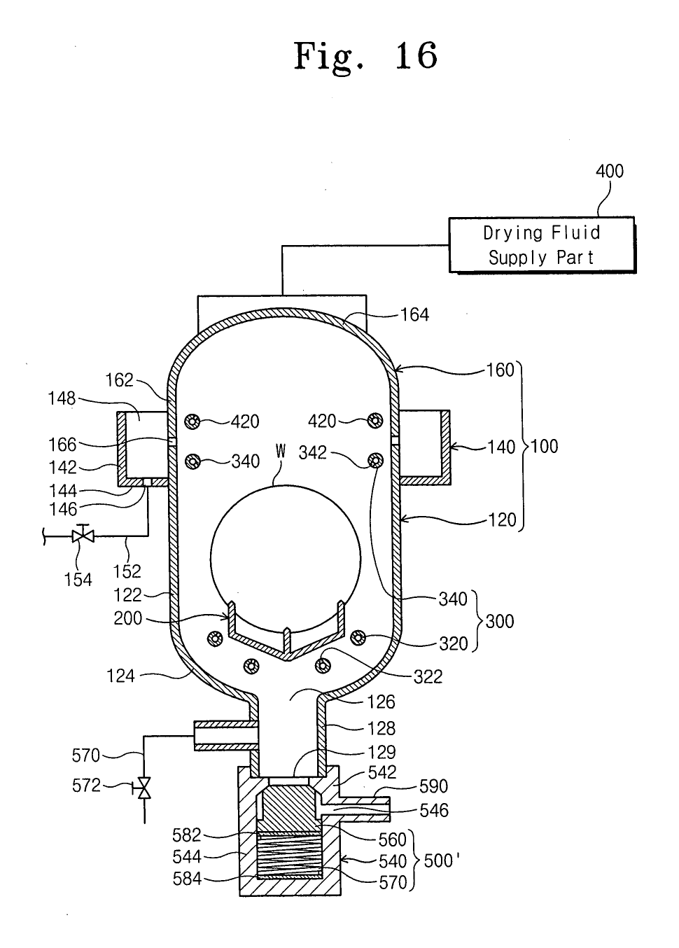

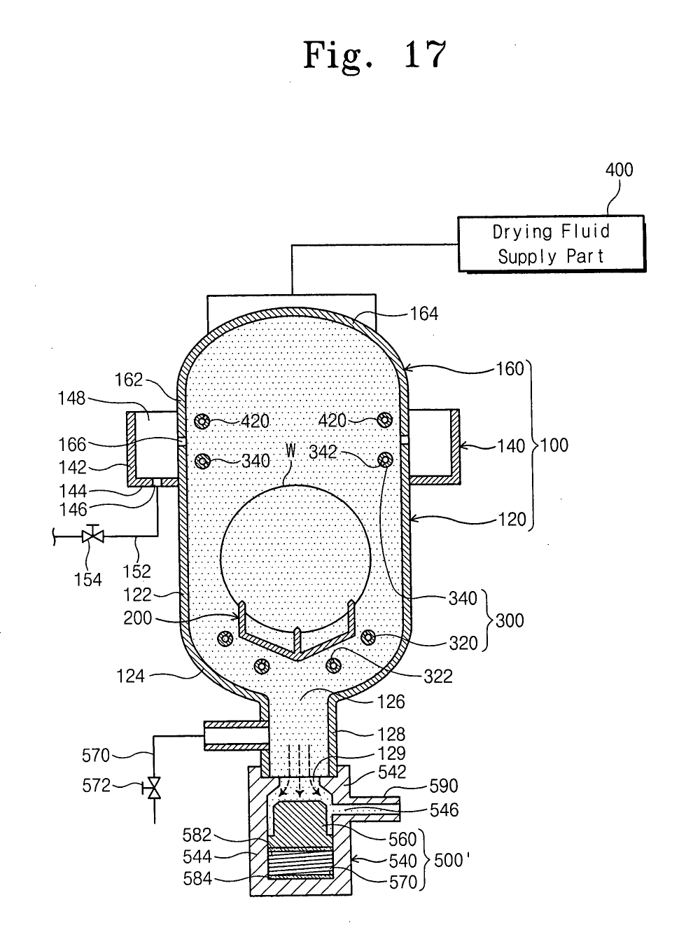

FIGS. 16 and 17 show another example of the pressure regulator. Referring to FIG. 16, the pressure regulator 500′ has a housing 540, an elastic body 570, and a cutoff rod 560. The housing 540 is connected to the exhaust port 128 formed at the bottom 124 of the chamber 100. The housing 540 has an opening 546 connected to a pipe 590 at one side thereof. The housing 540 also has an upper section 542 and a lower section 544. The upper section 542 delimits a space that becomes wider in a downward direction from the location at which the housing connects to the exhaust port 128. The lower section 544 delimits a space that extends perpendicularly downwardly from that of the upper section 542 and has the same cross-sectional area as that of the widest portion of the space delimited by the upper section 542. The cutoff rod 560 is disposed in the housing 540 to open and close the exhaust path 129 along which fluid is exhausted from the chamber 100. One end of the cutoff rod 560 has the same cross section as the exhaust path 129, and the other end thereof is fixed to a connecting plate 582. The elastic body 570 offers a constant force against the cutoff rod 560. One end of the elastic body 570 is disposed against a connecting plate 584 fixed to the bottom of the housing 540, and the other end thereof is disposed against a connecting plate 582 fixed to the cutoff rod 560. The elastic body 570 may be a coil spring. In any case, the elastic body 570 has a modulus of elasticity selected according to the pressure range required in the chamber 100.

In the case in which the pressure within the chamber 100 is low, the cutoff rod 560 completely blocks the exhaust path 129. However, if the inner pressure of the chamber 100 increases beyond a predetermined amount, the cutoff rod 560 moves down due to the pressure in the chamber 100, and the elastic body 570 is compressed. As the pressure becomes higher within the chamber 100, the elastic body becomes even more compressed. Thus, the cutoff rod 560 moves down and the degree to which the exhaust path 129 is open increases, as shown in FIG. 17. When the pressure regulator 500′ shown in FIG. 16 is used, it is not necessary to provide an active sensor for measuring the pressure within the chamber 100.

Also, a drain pipe 570 for draining DI water may be installed at one side of the exhaust port 128. An open/close valve 572 is installed in the drain pipe 570. Before a drying process starts, the exhaust path 129 is blocked by the cutoff rod 560 and the DI water is drained from the chamber 100 through the exhaust pipe 570 while the open/close valve 572 is opened. The open/close valve 572 is closed once the chamber 100 is completely drained.

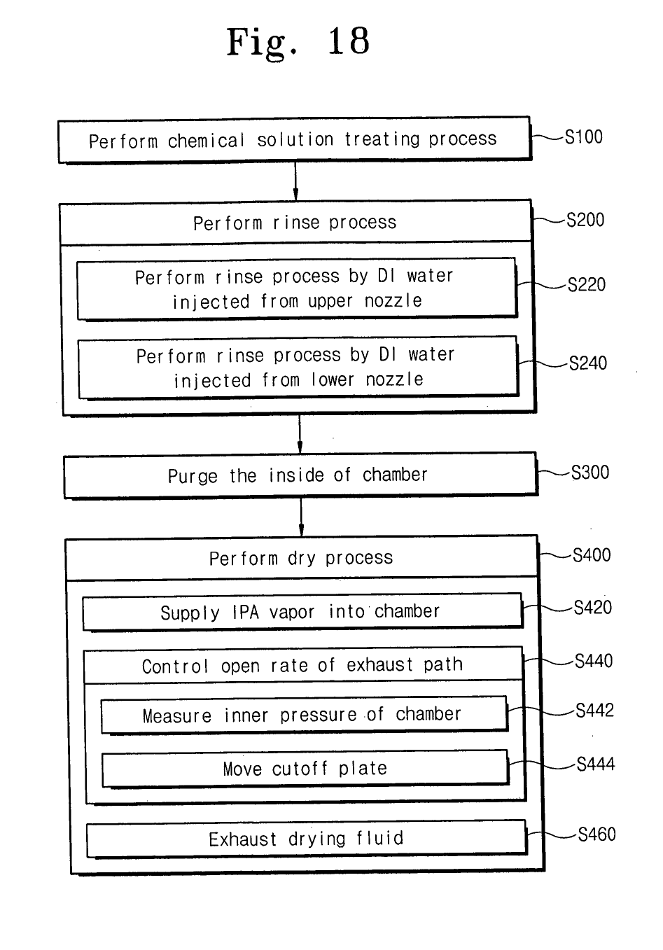

A wafer cleaning method according to the present invention will now be described with reference to a flowchart shown in FIG. 18 and the embodiment of the wafer cleaning apparatus shown in FIGS. 13-15. First, the inner bath 120 is filled with a chemical solution, such as hydrofluoric acid, and wafers “W” are submerged in the solution within the inner bath 120 (step S100). If contaminants attached to the wafers are removed by the chemical solution, a rinse process is performed to remove the chemical solution from the wafers “W” (step S200). DI water is directly injected onto the wafers “W” from the upper supply pipes 340 disposed at a level above the wafers “W”. Thus, hydrofluoric acid and contaminants attached to even fine patterns on the wafers “W” are removed (step S220). The supplying of the DI water from the upper supply pipe 340 is ceased, and DI water is supplied from the lower supply pipes 320. The DI water travels upwardly as a laminar flow in the inner bath 120, whereupon the DI water overflows into the outer bath 140 through the opening 166 (step S240). After a predetermined period of time elapses, the cutoff plate 524 is withdrawn from the exhaust port 128 such that the exhaust path 129 is opened. The inner bath 120 is thus drained through the exhaust path 129.

Next, a purge process is performed to purge the inside of the chamber 100 (step S300). The open/close valve 452 in the first supply pipe 450 is closed, and the open/close valve 462 in the second supply pipe 460 is opened. Simultaneously with or before the path through the first supply pipe 450 is opened, the vent pipe 490 connected to the evaporator 440 is opened. Accordingly, some of the IPA vapor in the evaporator 440 is vented to the outside through the vent pipe 490, and the remaining IPA vapor is supplied into the chamber 100. The vent pipe 490 is opened only once the drying process starts. After a predetermined period of time has elapsed, the amount of the IPA vapor flowing into the chamber 100 is regulated by adjusting the flow rate regulating valve 454 disposed in the first supply pipe 450. Furthermore, the open/close valve 462 is opened and the flow rate regulating valve 464 is controlled such that the amount of fluid supplied into the chamber 100 remains constant (step S420). Also, An the degree to which the exhaust path 129 is opened is such that the inner pressure of the chamber 100 is maintained within a predetermined range (step S440). To this end, the pressure in the chamber 100 is continuously measured during the process (step S442), and the cutoff plate 524 is positioned by the driving part 526 relative to the exhaust port 128 according to the measured pressure values (step S444). Once that part of the process using the IPA vapor is completed, the first supply pipe 450 is closed. Heated nitrogen gas is supplied into the second supply pipe 460 to dry the wafers “W” (step S460).

The present invention offers the following advantages. An exhaust path is regulated to maintain the internal pressure of the chamber within a predetermined range, to prevent the IPA vapor from being condensed. The amount of the IPA vapor can be controlled while keeping the total amount of fluid flowing into the chamber constant, whereby the density of the IPA vapor in the chamber may be high and condensation of the IPA vapor is prevented. An injection pipe for injecting drying fluid into the chamber and a supply pipe for supplying cleaning liquid into the chamber are installed at the sidewall of the chamber. Thus, the chamber may have a small volume which allows the process to be completed in a relatively short amount of time. A rinse process includes first rinsing the wafers with DI water injected onto the wafers directly from above the wafers, and secondly rinsing the wafers with a laminar flow of DI water. Therefore, contaminants can be removed from even a fine pattern on a wafer and at the same time are prevented from reattaching themselves to the wafer. A purge process is performed between the rinse process and the drying process, preventing hydrofluoric aid contained in the vapor in the chamber from acting on the IPA.

Although the present invention has been described hereinabove by way of preferred embodiments thereof, it can be modified, without departing from the spirit and nature of the subject invention as defined in the appended claims.

1. An apparatus for cleaning semiconductor substrates, comprising:
a chamber in which a cleaning process is performed, the chamber having an exhaust port defining an exhaust path along which fluid is exhausted from the chamber;
a substrate support disposed in said chamber, said support being configured to support semiconductor substrates within the chamber as the substrates are being processed in the chamber;
a fluid supply section connected to said chamber so as to supply fluid for drying the substrates into the chamber; and
regulating means for regulating the degree to which the exhaust path is open based on the pressure within said chamber.

2. The apparatus of claim 1, wherein said regulator comprises a cutoff plate, and a driving mechanism operatively connected to said cutoff plate so as to insert said cutoff plate into said exhaust path and withdraw said cutoff plate from said exhaust path.

3. The apparatus of claim 2, wherein said regulator further comprises a pressure sensor that measures the pressure within said chamber, and a controller operatively connected to said pressure sensor and to said driving mechanism so as to control the driving mechanism according to values of the pressure measured by said pressure sensor.

4. The apparatus of claim 1, wherein said regulator comprises a housing connected to said exhaust port so that the inside of said housing is in communication with the exhaust path, a resilient body disposed in said housing, and a cutoff member disposed in said housing and having a pressure-bearing surface communicating with the exhaust path such that the pressure of fluid in the chamber acts on said cutoff member, said resilient body biasing said cutoff member against the pressure in the chamber to a position that reduces the extent to which fluid can flow through the exhaust path, whereby the rate at which fluid can be exhausted from said chamber through the exhaust path is regulated according to the degree to which the resilient body is compressed and the pressure within said chamber.

5. The apparatus of claim 1, wherein said exhaust port is disposed below said substrate support in the chamber.

6. The apparatus of claim 1, wherein the exhaust path has a rectangular cross section.

7. The apparatus of claim 1, wherein said supply part section comprises an injection pipe having injection holes facing the interior of said chamber,
a first supply pipe connected to said injection pipe,
a first source of fluid to which said first supply pipe is connected such that said first supply pipe supplies fluid from said first source to said injection pipe,
a first flow rate regulating valve disposed in-line with said first supply pipe between said first source of fluid and said injection pipe,
a second supply pipe connected to said injection pipe, the second supply pipe branching from the first supply pipe at a location between the injection pipe and said flow rate regulating valve,
a second source of fluid to which said second supply pipe is connected such that said second supply pipe supplies fluid from said second source to said injection pipe, and
a second flow rate regulating valve disposed in-line with said second supply pipe.

8. The apparatus of claim 7, wherein said first source of fluid is a source of alcohol vapor, and said second source of fluid is a source of gas.

9. The apparatus of claim 7, wherein said injection pipe is disposed lengthwise within a sidewall of said chamber.

10. The apparatus of claim 9, wherein said supply section further comprises a heater operatively associated with said injection pipe so as to heat the injection pipe.

11. The apparatus of claim 7, wherein the injection holes of said injection pipe face upwardly.

12. The apparatus of claim 11, wherein said injection holes of the injection pipe comprise first, second and third groups of injection holes, a plane passing through the injection holes of the first group in a radial direction of the injection pipe subtending an angle of 5-20° with a horizontal plane, a plane passing through the injection holes of the second group in a radial direction of the injection pipe subtending an angle of 30-50° with a horizontal plane, and a plane passing through the injection holes of the third group subtending an angle of 60-80° with a horizontal plane.

13. The apparatus of claim 11, wherein a top of said chamber has the shape of a dome.

14. The apparatus of claim 7, wherein the cross-sectional area of the interior of said injection pipe decreases in a direction towards a distal end of the injection pipe remote from said first supply pipe.

15. The apparatus of claim 1, and further comprising cleaning liquid solution supply piping comprising an upper supply pipe disposed above said substrate support in an upper portion of said chamber at a level above the semiconductor substrates when the substrates are supported by said substrate support in the chamber, and a lower supply pipe disposed below said substrate support in a lower portion of said chamber at a level beneath the semiconductor substrates when the substrates are supported by said substrate support in the chamber.

16. The apparatus of claim 7, wherein said first source of fluid comprises an evaporating in which alcohol is evaporated, and further comprising a vent pipe connected to said evaporator such that vapor in the evaporator can be vented therefrom, and an openable and closable valve disposed in-line with the vent pipe.

17. A method of cleaning semiconductor substrates, comprising:
(a) rinsing a semiconductor substrate in a chamber with a cleaning liquid;
(b) subsequently draining the cleaning liquid from the chamber; and
(c) subsequently drying the semiconductor substrate in the chamber, wherein (c) comprises:
(c′) supplying a drying fluid into the chamber, and
(c″) while the drying fluid is being supplied into the chamber, exhausting the drying fluid from the chamber through an exhaust path, and regulating the rate at which the drying fluid is allowed to flow through exhaust path based on the pressure prevailing at the time within the chamber.

18. The method of claim 17, wherein (c″) comprises measuring the pressure within the chamber, and moving a plate into the exhaust path by an amount that corresponds to the measured pressure.

19. The method of claim 17, wherein (a) comprises:
(a′) injecting a cleaning fluid onto a semiconductor substrate from a location above the semiconductor substrate in the chamber, and
(a″) subsequently injecting a cleaning fluid into the chamber from a location beneath the semiconductor substrate in the chamber.

20. The method of claim 17, and further comprising purging the inside of the chamber with gas before said (c) drying of the semiconductor substrates in the chamber is initiated.
